(19) United States
(12) Patent Application Publication
(10) Pub. No.: US 2012/0300037 A1
(43) Pub. Date: Nov. 29, 2012

(54) THREE-DIMENSIONAL IMAGING SYSTEM USING A SINGLE LENS SYSTEM

(75) Inventor: John S. Laudo, Hilliard, OH (US)

(73) Assignee: BATTELLE MEMORIAL INSTITUTE, Columbus, OH (US)

(21) Appl. No.: 13/576,750

(22) PCT Filed: Jan. 31, 2011
(86) PCT No.: PCT/US2011/023142

§ 371 Date: Aug. 2, 2012

Related U.S. Application Data
(60) Provisional application No. 61/301,009, filed on Feb. 3, 2010.

(51) Int. Cl. H04N 13/02

(52) U.S. Cl. 348/46

(57) ABSTRACT

The passive imaging system of the present application includes first and second input polarizers on the light receiving side of a light receiving lens. A first half of the split polarizer performs vertical polarization of incoming light while the second half of the split polarizer performs horizontal polarization of the incoming light. The input polarizing structure provides parallax to accomplish 3D imaging. A third or interleaving polarizer is provided between the lens and an imaging device and is adjacent to and closely spaced from (<10 microns) the image plane of the device. The interleaving polarizer is sectional so that alternating sections, along the direction of parallax created by the input polarizer(s), pass vertically and horizontally polarized light. The resulting image frame formed at the image plane of the imager is similarly sectional so that sections of the image alternate between vertically polarized light and horizontally polarized light, e.g., for example the odd sections of the image are images of vertical polarized light (received from the left side) and even sections of the image are images of horizontally polarized light (received from the right side). Once an image frame has been captured, it is divided into two parallactic image frames, one of vertically polarized light imaged from the left side and one of horizontally polarized light imaged from the right side. The two resulting frames are combined to form a 3D image.

### TECHNICAL FIELD

The present invention relates in general to stereoscopic imaging for producing three-dimensional (3D) video signals and, more particularly, to a passive image pickup device and imaging system that generates three-dimensional signals for video presentation using polarizers and a single lens system.

### BACKGROUND ART

Typical single lens three-dimensional imaging systems use active devices, such as mechanical choppers, electro-optic switching elements or the like. The active devices are used to selectively pass or block portions of incoming light to create parallactic information such as that sensed by horizontally spaced human eyes. The active devices move to a first position to pass a first portion of received light and block a second to create a first image frame as it would be viewed from a first point, such as the left eye. The active devices then move to a second position to pass a second portion of received light and block the first to create a second image frame as it would be viewed from a second point, such as the right eye. The parallax frames are created sequentially so that two consecutive image frames are produced and the video update rate of the image is reduced by a factor of two. The slowed update rate can lead to unwanted, stilted motion in the video content.

### DISCLOSURE OF INVENTION

In the imaging system of the present application, parallactic information is passively captured using a single electronic imaging device, such as a charge-coupled device (CCD) or a complementary metal-oxide-semiconductor (CMOS) array element, and a single lens system in combination with input polarizing structure. Input polarizing structure is placed in front of the lens system so that light entering the input polarizing structure from a first side, for example the left side, is polarized into a first axis and light entering the input polarizing structure from a second side, for example the right side, is polarized into a second axis. Additional polarizing structure is placed between the single lens system and an imaging device with the additional polarizing structure having sections, such as vertical columns or horizontal rows, of polarizers with alternating first and second axes of polarization. Light reaching the image plane of the imaging device is interleaved and made up of alternating sections of light, as “seen” from the left side of the input polarizing structure and as “seen” from the right side of the input polarizing structure, respectively. Each image frame is separated into two parallax frames, one as seen from the left side of the input polarizing structure and one as seen from the right side of the input polarizing structure, with the two resulting parallax frames being three-dimensionally imaged using stereoscopic techniques.

In accordance with a first aspect of the invention, a three-dimensional imaging system is provided comprising: a single optical system having a single optical axis for receiving light to be imaged; an imaging device for receiving light passed through the single optical system; and first, second and third polarizing structures. The first polarizing structure polarizes light into a first axis and passes light to the single optical system. The second polarizing structure polarizes light into a second axis and passes light to the single optical system. The third polarizing structure comprises a plurality of sections for polarizing light received by the sections. Preferably, the sections alternately polarize light into the first axis and polarizes light into the second axis whereby the imaging device receives sections of the light to be imaged that are simultaneously received from the first polarizing structure and from the second polarizing structure.

The third polarizing structure may comprise a wire grid polarizer structure.

The first axis may be orthogonal to the second axis. The first axis may be horizontal and the second axis may be vertical.

The single optical system may comprise a single optical lens system.

The third polarizing structure may be spaced from the imaging device by less than 10 microns.

The first polarizing structure and the second polarizing structure may be formed on a light receiving surface of the single lens system.

The first polarizing structure may be a first polarizer and the second polarizing structure may be a second polarizer.

The first polarizing structure and the second polarizing structure may be formed as first and second halves of a single polarizer.

In accordance with a second aspect of the present invention, a method is provided for three-dimensional imaging comprising: polarizing light passing through a first polarizing structure into a first axis and passing the light through a single optical system having only a single optical axis; polarizing light passing through a second polarizing structure into a second axis and passing the light from the second polarizing structure through the optical system. The method may further comprise: passing light received from the single optical system for passage to an imaging device by polarizing first sections of the light received from the single optical system into the first axis and polarizing second sections of the light received from the single lens system into the second axis; and alternating the first and second sections of light received from the single optical system whereby light from the first polarizing structure is received by first sections of the imaging device and light from the second polarizing structure is received by interleaved second sections of the imaging device. The method may also comprise: generating first and second signals representative of the first and second sections of light, respectively; separating the first and second signals into first and second image frames; and combining the first and second image frames into three-dimensional images.

In accordance with a third aspect of the present invention, a three-dimensional imaging system is provided comprising: a single optical system having a single optical axis for receiving light to be imaged; an imaging device for receiving light passed through the optical system; and first, second and third polarizing structures. The first polarizing structure polarizes light into a first axis and passes light to the optical system. The second polarizing structure polarizes light into a second axis and passes light to the optical system. The third polarizing structure comprises a plurality of first and second interleaved sections. The first sections of the third polarizing structure pass light polarized by the first polarizing structure to the imaging device and the second sections of the third polarizing structure pass light polarized by the second polarizing structure to the imaging device. The imaging device receives interleaved sections of the light polarized into the first axis and the light polarized into the second axis.

### BRIEF DESCRIPTION OF DRAWINGS

FIG. 1 schematically shows an illustrative embodiment of the imaging system of the present application;

FIG. 2 is a perspective view of a wire grid polarizer (WGP) which can be used as polarizing structure for the imaging system of the present application; and

FIG. 3 illustrates a possible architecture for the alignment and fixturing of polarizing structure to the image plane of a camera chip.

### BEST MODE FOR CARRYING OUT THE INVENTION

In the imaging system of the present application, parallactic information is passively captured using a single electronic imaging device, such as a CCD or a CMOS array element, and a single lens system in combination with polarizing structures. More particularly, an input polarizer is placed in front of the lens system. Two input polarizers or a single polarizer divided into two different polarizing portions, each being about half of the single polarizer, can be used. Light entering a first polarizer or first side of a single polarizer, for example the left side, is polarized into a first axis, for example the vertical axis. Light entering a second polarizer or second side of a single polarizer, for example the right side, is polarized into a second axis, for example the horizontal axis.

Additional polarizing structure is placed between the single lens system and an imaging device. This third or interleaving polarizing structure is made up of sections of polarizers that have alternating axes of polarization. That is, the first section polarizes into the first axis (vertical); the second section polarizes into the second axis (horizontal); the third section polarizes into the first axis (vertical); the fourth section polarizes into the second axis (horizontal); etc. across the polarizer. In this way, light reaching the image plane of the imaging device is simultaneously interleaved so that it is made up of alternating sections of light as “seen” from the left side of a single input polarizer, when a single input polarizer is used, and as “seen” from the right side of the single input polarizer, respectively. Each image frame that is captured is separated into two parallax frames, one as seen from the left side of the input polarizer and one as seen from the right side of the input polarizer, with the two resulting parallax frames being three-dimensionally imaged using conventional stereoscopic techniques. Since the parallax frames are created from a single image, the video update rate of the image is not reduced.

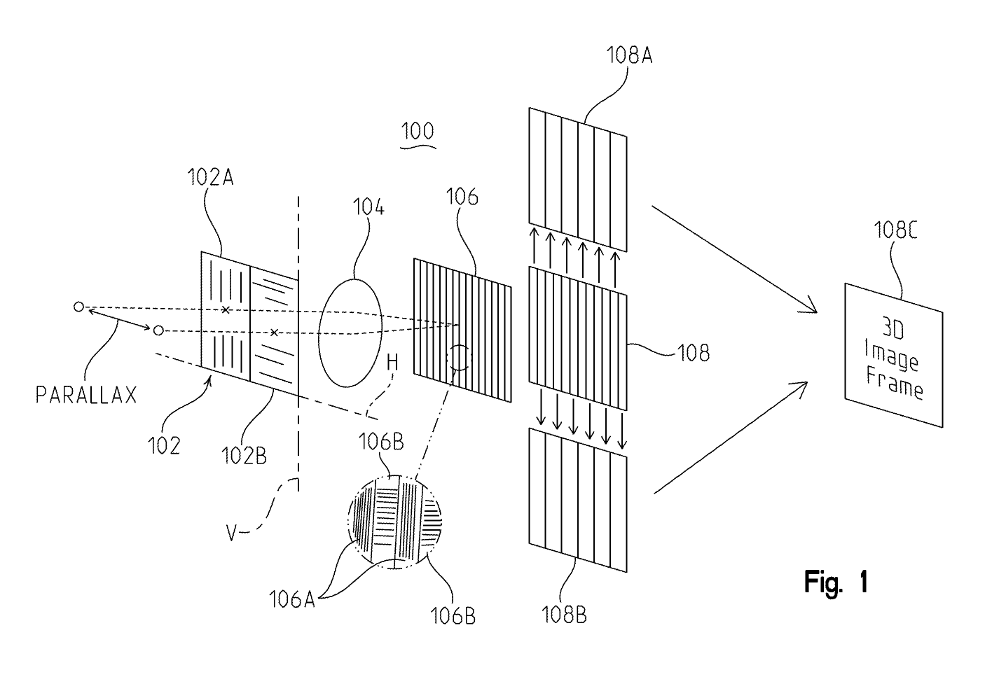

An illustrative embodiment of the imaging system 100 of the present application is schematically shown in FIG. 1. An input polarizer 102 is positioned on the light receiving side of a light receiving single optical system having a single optical axis, which, in the illustrated embodiment, comprises a single lens system 104. The single lens system 104 may comprise a singlet, achromatic doublet or compound lens, such as a macro lens, double gauss or other multi-element lens, e.g., a Carl Zeiss Vario-Sonnar lens. The single lens system 104 does not comprise two distinct lenses having separate optical axes. Because the single optical system comprises only a single optical axis, there is no need to correction registration errors, which might result if separate light portions are traveling along two different misaligned optical axes. As described below, the input polarizer can be formed directly on an input surface of a single lens system. A first half 102A of the input polarizer 102 (or first polarizer) performs polarization of incoming light into a first axis. As illustrated, the first half 102A is the left side of the polarizer 102 and the polarization first axis is the vertical axis V. Polarization of incoming light received by the second half 102B of the input polarizer 102 (or second polarizer) is polarized into a second axis, preferably orthogonal to the first axis. As illustrated, the second half 102B is the right side of the polarizer 102 and the polarization second axis is the horizontal axis H. The closely spaced lines in the first and second halves 102A and 102B of the polarizer 102 indicate the direction of polarization.

An interleaving polarizer 106 (or third polarizer) is provided between the lens system 104 and an imaging device 108 with the polarizer 106 being adjacent to and closely spaced from (<10 microns) the image plane of the imaging device 108. The imaging device 108 can be a CCD or CMOS device, as noted above. While a variety of imaging devices can be used in the imaging system of the present application, two suitable commercially available devices are Omivision's OV2710 and Sony's IMX017CQE. The interleaving polarizer 106 is made up of sections of polarizers which are arranged so that alternating sections of the polarizer 106 pass vertically and horizontally polarized light. In the illustrated embodiment, the sections of polarizers are vertical columns. However, it is contemplated that the sections of polarizers could be horizontal rows. For example, odd numbered sections 106A of the polarizer 106 can pass vertically polarized light, but effectively block horizontally polarized light, and even numbered sections 106B of the polarizer 106 can pass horizontally polarized light, but effectively block vertically polarized light. The closely spaced lines in the odd and even sections 106A and 106B in FIG. 1 indicate the direction of polarization.

After light from a scene to be imaged passes through the input polarizer 102, the single lens system 104 and the interleaving polarizer 106, the image frame formed at the image plane of the imaging device 108 is made up of sections of image data that are produced in interleaved sections, interleaved vertical sections in the illustrated embodiment, by vertically polarized light and horizontally polarized light. As described above, for example, the odd sections, i.e., odd columns in the illustrated embodiment, of the image are images of vertically polarized light (received from the first half 102A of the input polarizer 102) and even sections, i.e., even columns in the illustrated embodiment, of the image are images of horizontally polarized light (received from the second half 102B of the input polarizer 102). Once an image frame has been captured, it is divided into two image frames 108A, 108B using conventional image processing software, one of vertically polarized light imaged from the first half 102A of the input polarizer and one of horizontally polarized light imaged from the second half 102B of the input polarizer. The two resulting frames 108A, 108B are combined to form a three-dimensional image frame 108C using conventional stereoscopic techniques.

The imaging system of the present application is compact, essentially being the same size as a normal lens or camera system, but allowing three-dimensional image capture. Removal of the polarizing structures enables the lens or camera system to return to non-three-dimensional operation at increased resolution.

The interleaving polarizer 106 can be produced using wire grid polarizers (WGPs). Advances in lithographic and microfabrication techniques have enabled the fabrication of metal lines on the order of 100 nm using standard techniques. The ability to create metal lines of these dimensions enables production of polarizing structures on a scale which is small enough to allow the polarization of the visible light spectrum. By controlling the period, the duty cycle, the thickness and material types, WGPs are able to polarize light with high efficiency.

Calculations for sizing WGP gratings can be carried out using a rigorous coupled wave analysis program available from Grating Solver Development Company of Allen, Tex. (see www.Gsolver.com). To form WGP gratings, thin metal lines are formed on glass using, for example, nano-lithography, such as on a separate glass element, to act as high transmission polarizers across the entire visible spectrum (400 nm to 700 nm). WGP gratings may also be formed via metal deposition on glass followed by focused ion beam milling

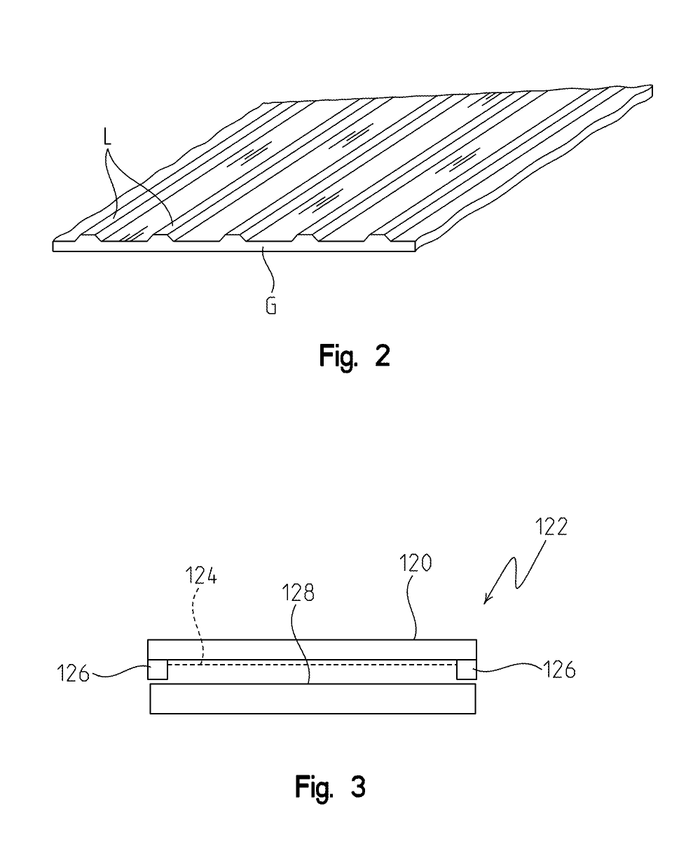

In order to find an acceptable WGP grating sizing for the interleaving polarizer 106 of the present application, the period and thickness of the lines were varied at a duty cycle of 50% until maximum transmission was achieved. Then the duty cycle was adjusted to further flatten the response of the polarizer across the spectrum. The thickness was minimized as well to reduce the fabrication time by ion milling. The following parameters were obtained: period—150 nm; thickness of Aluminum—130 nm; duty Cycle—30% metal, 70% open; and rectangular profile as illustrated in FIG. 2, where Aluminum lines L formed on glass G are illustrated.

Variability in the refractive index, the line uniformity, substrate material and other fabrication errors can erode the performance of WGP gratings. Because the line widths are small, debris and fabrication errors are important in determining the overall performance. In general, however the ability to create a polarizer over such a broad spectral band with a wide angle of incidence, are advantageous aspects of this technology.

Additionally, graded-index structures can be added to the metal lines to further improve the contrast of the polarizers. See the following references for more information.
“Wire-grid diffraction gratings used as polarizing beam splitter for visible light and applied in liquid crystal on silicon” M. Xu, H. P. Urbach, D. K. G de Boer, and H. J. Cornelissen, 4 Apr. 2005/Vol. 13, No. 7/OPTICS EXPRESS 2305
“The facile fabrication of a wire-grid polarizer by reversal rigiflex printing” Tae-il Kim and Soon-min, 2009 Nanotechnology 20 145305 (6 pp)
“Optically bifacial thin-film wire-grid polarizers with nano-patterns of a graded metal-dielectric composite layer” Jong Hyuk Lee, Young-Woo Song, Kyu H. Hwang, Joon-gu Lee, Jaeheung Ha, and Dong-Sik Zang, Optics Express, Vol. 16, Issue 21, pp. 16867-16876

Variations on the above description are known as a means to enhance contrast between polarizations. Those variants of the polarizer construction can be used as necessary for given applications.

Using the design described above, the interleaving polarizer 106 is created in alternating sections for each pixel section in the imaging device. The metal lines run perpendicular to each other for any two adjacent sections. Currently pixels widths of 2.5 to 3 microns are envisioned as the section width sizes. The small pixel/section width size is to minimize the eventual size of the polarizer area for ease of fabrication.

As noted above, it is also possible to use focused ion beam milling to fabricate the metal lines of the interleaving polarizer 106 on glass. Ion Beam Milling is capable of carving <50 nm features in a variety of materials and provides a direct feedback fabrication approach for initial fabrication. An FEI Helios NanoLab 600 Focused Ion Beam Mill/Scanning Electron Microscope (FIB/SEM) can be used for fabrication. Aluminum coated glass substrates can be used with the aluminum deposited to the appropriate thickness of about 130 nm. The ion beam milling process removes aluminum material from a glass substrate such that lines of remaining aluminum material define the metal lines of the polarizer. Stitching errors must be addressed in software and controlled so that alignment from 200 micron field to 200 micron field is maintained across the chip, and so that one section does not “drift” into the next section. Ultimately, a nano-lithography process using a high quality master can be used for low cost production.

The exact architecture of the alignment and fixturing of an interleaving polarizer to an image plane will be imaging device dependent. With reference to FIG. 3, the imaging device 108 comprises a CCD 122. The cover glass 120 of the CCD 122 is removed in an inert atmosphere, such as Argon or Nitrogen. The interleaving polarizer 124 is placed with the metal lines side facing the CCD focal plane. The interleaving polarizer 124 is aligned via microscope inspection of the pixel plane through the back of the polarizer. To create the short standoff distance (<10 microns) between the polarizer 124 and the active CCD focal plane, Silicon Dioxide or Sylgard (PDMS) standoff features 126 will be deposited onto the borders of the polarizer 124, prior to the FIB milling. These pads will provide the proper height plateaus for registration of the glass to the CCD. These features 126 will register the glass 120 to the CCD silicon plane 128 at the edges of the active pixel area. Once aligned and registered in place, the glass 120 will be UV cured permanently, by edge bonds.

The input polarizer 102 on the front of the single lens system 102 can be made of a thin film process or wire grid technology. Wire grid technology, though, may be too costly for a large lens. The wire grid polarizer has extremely small intricate lines of metal with small spacings. Placing these lines on a lens of large area, e.g., 50 mm×50 mm, may be costly to do using ion milling or other lithography. Thin films on glass separate from a single lens system are more likely polarizers, at least for initial embodiments. A transition region between each half of the polarizer 102 is envisioned with a small vertical line of obscuration (<100 microns) to eliminate the passage of light that is not polarized in either state.

Having described the imaging system of the present application in detail and by reference to specific embodiments, it will be apparent that modifications and variations are possible without departing from the scope of the invention as defined in the appended claims. While the imaging system of the present application is described with reference to visible light, imaging systems operating in other frequency regions of the “light” spectrum, such as Infrared, UV and even X-ray regions of the spectrum, are contemplated using the teachings of the present application. As long as the polarizers can be built, and there is an imager to receive the radiation, a 3D image can be captured regardless of the wavelength of the radiation. Accordingly, it is to be understood that “light,” as used herein, is not to be considered to be restricted to the visible spectrum.

1. A three-dimensional imaging system comprising:
a single optical system having a single optical axis for receiving light to be imaged;
an imaging device for receiving light passed through said single optical system;
a first polarizing structure for polarizing light into a first axis, said first polarizing structure passing light to said single optical system;
a second polarizing structure for polarizing light into a second axis, said second polarizing structure passing light to said single optical system; and
a third polarizing structure comprising a plurality of sections for polarizing light received by said sections, said sections alternately polarizing light into said first axis and polarizing light into said second axis whereby said imaging device receives sections of said light to be imaged that are simultaneously received from said first polarizing structure and said second polarizing structure.

2. The three-dimensional imaging system of claim 1 wherein said first axis is orthogonal to said second axis.

3. The three-dimensional imaging system of claim 1 wherein said first axis is horizontal and said second axis is vertical.

4. The three-dimensional imaging system of claim 1 wherein said single optical system comprises a single lens system.

5. The three-dimensional imaging system of claim 4 wherein said first polarizing structure and said second polarizing structure are formed on a light receiving surface of said single lens system.

6. The three-dimensional imaging system of claim 1 wherein said third polarizing structure is spaced from said imaging device by less than 10 microns.

7. The three-dimensional imaging system of claim 1 wherein said first polarizing structure is a first polarizer and said second polarizing structure is a second polarizer.

8. The three-dimensional imaging system of claim 1 wherein said first polarizing structure and said second polarizing structure are formed as first and second halves of a single polarizer.

9. The three-dimensional imaging system of claim 1, wherein said third polarizing structure comprises a wire grid polarizer structure.

10. A method for three-dimensional imaging comprising:
polarizing light passing through a first polarizing structure into a first axis and passing said light through a single optical system having only a single optical axis;
polarizing light passing through a second polarizing structure into a second axis and passing said light from said second structure through said optical system;
passing light received from said single optical system for passage to an imaging device by polarizing first sections of said light received from said single optical system into said first axis and polarizing second sections of said light received from said single optical system into said second axis;
alternating said first and second sections of light received from said single optical system whereby light from said first polarizing structure is received by first sections of said imaging device and light from said second polarizing structure is received by interleaved second sections of said imaging device;
generating first and second signals representative of said first and second sections of light, respectively;
separating said first and second signals into first and second image frames; and
combining said first and second image frames into three-dimensional images.

11. A three-dimensional imaging system comprising:
a single optical system having a single optical axis for receiving light to be imaged;
an imaging device for receiving light passed through said optical system;
a first polarizing structure for polarizing light into a first axis, said first polarizing structure passing light to said optical system;
a second polarizing structure for polarizing light into a second axis, said second polarizing structure passing light to said optical system; and
a third polarizing structure comprising a plurality of first and second interleaved sections, said first sections of said third polarizing structure passing light polarized by said first polarizing structure to said imaging device and said second sections of said third polarizing structure passing light polarized by said second polarizing structure to said imaging device, whereby said imaging device receives interleaved sections of said light polarized into said first axis and said light polarized into said second axis.

12. The three-dimensional imaging system of claim 11 wherein said first axis is orthogonal to said second axis.

13. The three-dimensional imaging system of claim 11 wherein said first axis is horizontal and said second axis is vertical.

14. The three-dimensional imaging system of claim 11 wherein said third polarizing structure is spaced from said imaging device by less than 10 microns.

15. The three-dimensional imaging system of claim 11, wherein said single optical system comprises a single lens system.

16. The three-dimensional imaging system of claim 11, wherein said third polarizing structure comprises a wire grid polarizer structure.
